(19) United States
(12) Patent Application Publication
(10) Pub. No.: US 2023/0127718 A1
(43) Pub. Date: Apr. 27, 2023

(54) POTTED PLANT RISER FOR CRAWLING INSECT ACCESS PREVENTION

(71) Applicant: James Kelly, Denver, CO (US)

(72) Inventor: James Kelly, Denver, CO (US)

(21) Appl. No.: 17/510,563

(22) Filed: Oct. 26, 2021

(51) Int. Cl. A01G 13/10; A47G 7/04; A01M 1/10

(52) U.S. Cl. CPC A01G 13/105; A47G 7/041; A01M 1/10

(57) ABSTRACT

Potted plant riser assemblies are provided for preventing small, crawling insects from accessing cultivated plants. Embodiments of the potted plant riser assembly can include an outer wall structure that defines an outer ground boundary. The outer wall structure surrounds a capture trough, which surrounds a riser structure. The capture trough has insect capture material disposed therein. The riser structure includes an elevated platform on which to place (or integrate) a planter for cultivating a plant. The potted plant riser assembly also includes an eaves structure designed to permit entry of small, crawling insects into the capture trough, while also shielding the capture trough from entry of debris and from run-off of water, soil, and the like from the plant and planter.

### FIELD

Inventions described herein relate generally to receptacles for cultivation of plants; more particularly, embodiments relate to potted plant risers for crawling insect access prevention, such as for preventing spider mites and other small crawling insects from accessing potted plants.

### BACKGROUND

Successful cultivation of a crop can often depend on preventing the crop from becoming infested by harmful pests. Some crops are particularly susceptible to small crawling insects, such as spider mites. Many of these pests are very small. For example, an adult spider mite is typically only around a half-millimeter long. As such, a spider mite can easily be transported accidentally into a cultivation facility on a person's shoes, after which the spider mite can crawl up the side of a planter and onto a plant. Once there, the spider mite's presence may be practically undetectable until an infestation has begun. Once such an infestation has begun, it can often be extremely difficult to stop. For example, under optimal reproduction conditions, even a small number of spider mites can turn into an infestation of millions within weeks. Further, certain populations of such pests can have a very high resistance to conventional remediation measures. For example, particular types of spider mites have demonstrated a particularly high resistance to insecticides.

### BRIEF SUMMARY

Embodiments provide novel types of potted plant riser assemblies for preventing small, crawling insects from accessing cultivated plants. Embodiments of the potted plant riser assembly can include an outer wall structure that defines an outer ground boundary. The outer wall structure surrounds a capture trough, which surrounds a riser structure. The capture trough has insect capture material disposed therein. The riser structure includes an elevated platform on which to place (or integrate) a planter for cultivating a plant. The potted plant riser assembly also includes an eaves structure designed to permit entry of small, crawling insects into the capture trough, while also shielding the capture trough from entry of debris and from run-off of water, soil, and the like from the plant and planter.

According to one set of embodiments, a potted plant riser assembly is provided. The assembly includes: an outer wall structure extending from a ground level to a first elevation above the ground level; a riser structure configured to support a bottom of a planter at a second elevation above the first elevation; a capture trough surrounding the riser structure, bounded at least partially by the outer wall structure, and sized to removably receive insect capture material; and an eaves structure configured, in an assembled mode, to provide full over-cover of the capture trough, to extend radially past the outer wall structure, and to terminate at a third elevation between the ground and the first elevation.

According to another set of embodiments, a kit is provided. The kit includes: potted plant riser assembly comprising: an outer wall structure extending from a ground level to a first elevation above the ground level and defining an outer ground perimeter; a riser structure configured to support a bottom of a planter at a second elevation above the first elevation; a capture trough surrounding the riser structure, bounded at least partially by the outer wall structure, and sized to removably receive insect capture material; and an eaves structure configured, in an assembled mode, to provide full over-cover of the capture trough, to extend radially past the outer wall structure, and to terminate at a third elevation between the ground and the first elevation; the insect capture material; and packaging configured to hold the potted plant riser and the insect capture material.

### BRIEF DESCRIPTION OF THE DRAWINGS

The accompanying drawings, referred to herein and constituting a part hereof, illustrate embodiments of the disclosure. The drawings together with the description serve to explain the principles of the invention.

FIGS. 1A and 1B show an illustrative potted plant riser assembly, according to various embodiments described herein.

FIG. 2 shows top and bottom views of the ground component and the skirt component of the illustrative potted plant riser assembly of FIG. 1B.

FIG. 3 shows a cut view of an illustrative potted plant riser assembly in which the outermost boundary of the outer wall structure is not the location of point of falls outside the full circumferential contact with the ground surface.

FIG. 4 shows a cut view of an illustrative potted plant riser assembly in which the skirt component only includes the eaves structure.

FIGS. 5A and 5B show cut views of two embodiments of an illustrative potted plant riser assembly in which the outer wall structure and the capture trough are integrated into the ground component, and the riser structure and the eaves structure are integrated into the skirt component.

FIGS. 6 and 7 show top views of illustrative ground components, respectively, both having a hexagonal planar shape.

FIG. 8 shows another top view of an illustrative ground component having a non-solid planar shape.

FIG. 9 shows a top view of an illustrative skirt component having a door substructure.

FIG. 10 shows a cut view of another illustrative skirt component having an integrated planter.

FIG. 11 shows a kit of parts for a potted plant riser assembly, according to various embodiments.

In the appended figures, similar components and/or features can have the same reference label. Further, various components of the same type can be distinguished by following the reference label by a second label that distinguishes among the similar components. If only the first reference label is used in the specification, the description is applicable to any one of the similar components having the same first reference label irrespective of the second reference label.

### DETAILED DESCRIPTION

In the following description, numerous specific details are provided for a thorough understanding of the present invention. However, it should be appreciated by those of skill in the art that the present invention may be realized without one or more of these details. In other examples, features and techniques known in the art will not be described for purposes of brevity.

Successful cultivation of a crop can often depend on preventing the crop from becoming infested by harmful pests. Some crops are particularly susceptible to small crawling insects, such as spider mites. Many of these pests are very small. For example, an adult spider mite is typically only around a half-millimeter long. As such, a spider mite can easily be transported accidentally into a cultivation facility on a person's shoes, after which the spider mite can crawl up the side of a planter and onto a plant. Once there, the spider mite's presence may be practically undetectable until an infestation has begun. Once such an infestation has begun, it can often be extremely difficult to stop. For example, under optimal reproduction conditions, even a small number of spider mites can turn into an infestation of millions within weeks. Further, certain populations of such pests can have a very high resistance to conventional remediation measures. For example, a particular type of spider mite with two spots on its back has demonstrated a particularly high resistance to insecticides.

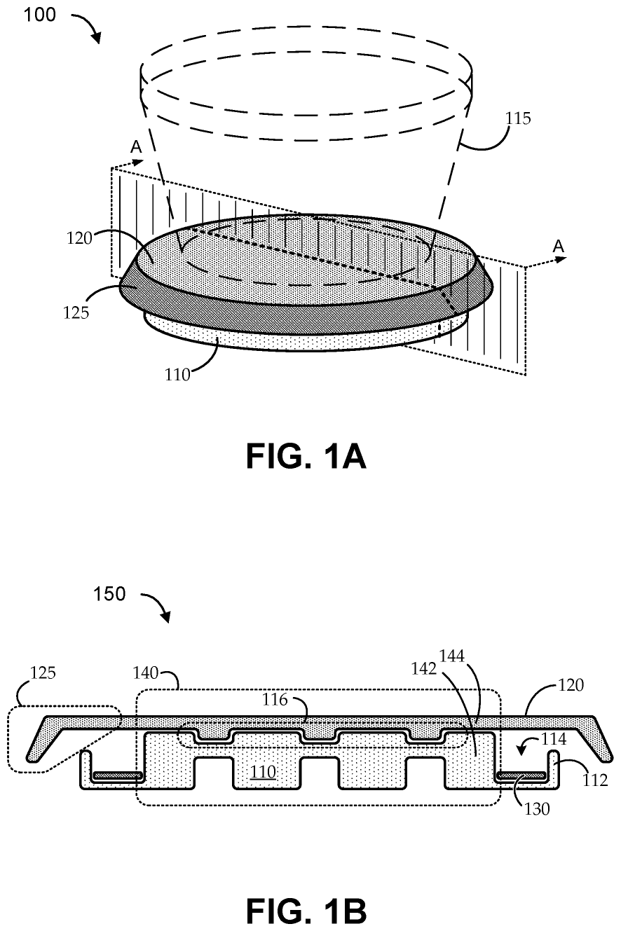

Embodiments described herein include novel potted plant risers designed to prevent crawling insects from gaining access to a cultivated plant. FIGS. 1A and 1B show an illustrative potted plant riser assembly 100, according to various embodiments described herein. FIG. 1A shows a perspective assembled view of the illustrative potted plant riser assembly 100. For added context, an illustrative planter 115 is shown placed on top of the potted plant riser assembly 100. Embodiments can be described as including a ground component 110 and a skirt component 120. As described herein, the ground component 110 includes at least an outer wall structure and a capture trough. The skirt component 120 includes at least an eaves structure 125 that overhangs the ground component 110 without contacting the outer wall structure.

It can be assumed that the potted plant riser assembly 100 is placed in a flat and upright manner on a ground surface (not shown), such as on dirt, pavement, tile, concrete, etc. The ground component 110 (at least the outer wall structure) is configured to be in full circumferential contact with the ground surface when the potted plant riser assembly is placed in such a manner on the ground surface. Such full circumferential contact prevents ground access to the planter 115 by crawling insects from all directions. The only route from the ground to the planter 115 is via the outer wall structure, and any crawling insect that successfully scales the outer wall structure will be captured or deterred by the capture trough.

FIG. 1B shows an illustrative cut view 150 of the potted plant riser assembly 100 cut along cut plane A of FIG. 1A. FIG. 1B is intended only to represent one illustrative internal structural arrangement of the potted plant riser assembly 100 of FIG. 1A; many variations are possible, including those described throughout this disclosure. The potted plant riser assembly 100 includes the ground component 110 as a first unitary structure and the skirt component 120 as a second unitary structure. As used herein, the terms “component” and “unitary structure” are intended to mean that the component or unitary structure is either manufactured as a single piece, or manufactured to act as a single piece from the end consumer perspective (i.e., not intended to be disassembled, or otherwise separable by a consumer). In some implementations, one or both components is manufactured from a single piece of material, such as by injection or other molding, three-dimensional printing, computer numerical controlled (CNC) milling, or any other suitable process. In other implementations, one or both components includes subcomponents that are coupled together using friction fitting, snap fitting, chemical fasteners, mechanical fasteners, or any other suitable manner of joining.

The potted plant riser assembly 100 includes at least an outer wall structure 112, a capture trough 114, a riser structure 140, and an eaves structure 125. Embodiments of the outer wall structure 112 extend from a ground level to a first elevation above the ground level and provide a number of features. For example, the outer wall structure 112 can be a vertical, or nearly vertical wall structure. According to one feature, the outer wall structure 112 is configured to define an outer ground perimeter for the potted plant riser assembly 100, such that any small insect attempting to crawl up the potted plant riser assembly 100 from any direction first comes in contact with the outer wall structure 112. According to another feature, the outer wall structure (in some cases, with help from the eaves structure 125) can help limit water (e.g., and/or dirt and other debris) from entering the capture trough 114. For example, in hydroponic cultivation environment, such as a hydroponic table setup, water can tend to flow in various directions, including back toward a plant (e.g., backflow water). As water flows around the hydroponic environment, the elevation of the outer wall structure 112 can help ensure that such backflow water does not enter the capture trough 114 and interfere with operation of insect capture material 130 in the capture trough 114 (as described below).

Another feature of the outer wall structure 112 can be to surround and/or bound the capture trough 114. Embodiments of the capture trough 114 are configured to surround the riser structure 140 and be bounded at least partially by the outer wall structure 112. The capture trough 114 is also sized to removably receive insect capture material 130. In some implementations, the insect capture material 130 includes solid and/or liquid material that is poured into the capture trough 114 to form a contiguous ring of insect capture material 130 around the riser structure 140. For example, the insect capture material 130 can include pepper, eggshells, soapy water, ethylene glycol, diatomaceous earth, insecticide, and/or any other suitable substances for deterring, killing, and/or trapping small, crawling insects. As described herein, embodiments can permit removal and replacement of such insect capture material 130 by providing sufficient access to the capture trough 114 to allow the used insect capture material 130 to be poured out from the capture trough 114, and new insect capture material 130 to be poured into the capture trough 114. In other implementations, the insect capture material 130 is formed on a substrate shaped to fit within the capture trough 114 and to follow a planar contour of the capture trough 114. In context of the illustrated embodiment, the capture trough 114 follows a generally circular planar path (i.e., a circular ring around the riser structure 140), and the substrate can be formed as a circular ring insert that can be placed into the capture trough 114. In some such implementations, the substrate is covered by, soaked in, and/or made out of a material that traps, deters, and/or kills small, crawling insects. For example, the substrate can be covered by a is covered by a sticky material to trap crawling insects, a poisonous material (e.g., an insecticide) to kills crawling insects, etc. As described herein, embodiments can permit removal and replacement of such insect capture material 130 by providing sufficient access to the capture trough 114 to allow the used insect capture material 130 substrate to be removed from the capture trough 114, and a new insect capture material 130 substrate to be placed into the capture trough 114.

Embodiments of the riser structure 140 are configured to support the bottom of a planter above the ground level and within the protective ring formed by the capture trough 114 and the outer wall structure 112. In general, the riser structure 140 can be considered as having an elevation portion 142 and a platform portion 144. The platform portion 144 is configured to provide a platform on which to support the bottom of a planter (e.g., or to couple with a bottom of a planter, or to integrate with a bottom of a planter, such as described below). The platform portion 144 is, or is configured to be, on top of the elevation portion 142, such that the elevation portion 144 raises the level of the platform portion 142 to a desired elevation. In the illustrated embodiment, the elevation portion 142 is integrated into the ground component 110, and the platform portion 144 is integrated into the skirt component 120. In other embodiments, such as those described below, the elevation portion 142 and the platform portion 144 can both be integrated into the ground component 110, or can both be integrated into the skirt component 120.

The embodiments illustrated herein generally show the riser structure 140 as configured to support the bottom of a planter at a second elevation above the first elevation (i.e., at an elevation above the top of the outer wall structure 112). In some embodiments, the riser structure 140 is configured to support the bottom of a planter at an elevation below the first elevation. It can be seen that an outer perimeter of the riser structure 140 can also act as an inner wall of the capture trough 114 (i.e., the capture trough 114 is a trough formed between the outer wall structure 112 and an outer perimeter of the riser structure 140, such as illustrated). In embodiments where the riser structure 140 is configured to support the bottom of a planter at an elevation below the first elevation, an additional inner wall structure can be added to the capture trough 114 to maintain the trough shape. The additional inner wall structure can be considered as part of the capture trough 114, or as part of the riser structure 140.

Embodiments of the eaves structure 125 are configured to provide full over-cover of the capture trough 114, to extend radially past the outer wall structure 112, and to terminate at a third elevation between the ground and the first elevation. In the illustrated embodiment, the eaves structure 125 is integrated with the platform portion 144 of the riser structure 140 to extend the platform. By extending over the entirety of the capture trough 114 and then terminating at an elevation below that of the top of the outer wall structure 112, the eaves structure 125 prevents water, dirt, pollen, flying insects, and/or other debris from getting into the capture trough 114 (e.g., and getting stuck in, covering, and/or otherwise interfering with operation of the insect capture material 130). Also in the illustrated embodiment, the outer portion of the eaves structure 125 extends downward in a diagonal fashion to help ensure that water and/or other liquids (e.g., rain, irrigation, etc.) runs of the ends of the eaves structure 125 without falling back into the capture trough 114. Also in the illustrated embodiment, the outer edge of the eaves structure 125 is far enough above the ground level to allow for the entry of small, crawling insects and to avoid contact with ground elements (e.g., small pebbles, and/or other ground elements that can provide an alternate path for a small, crawling insect to reach the eaves structure 125 directly without traversing the outer wall structure 112 and the capture trough 114). However, the outer edge of the eaves structure 125 can also be low enough to shield the capture trough 114 from entry of debris. In some implementations, the outer edge of the eaves structure 125 can also be low enough to limit entry of larger insects, rodents, and/or other pests into the capture trough 114.

The potted plant riser assembly 100 is typically in an assembled mode during normal operation. In the illustrated embodiment, the assembled mode involves placing the skirt component 120 on top of the ground component 110 with insect capture material 130 in the capture trough 114. Some embodiments of the potted plant riser assembly 100 include an accessibility interface structure 116 to provide human access to the capture trough 114 for the purpose of removing and replacing insect capture material 130, as desired. Embodiments of the accessibility interface structure 116 can include a first portion and a second portion that are mutually configured to operate in either of the assembled mode or a maintenance mode. The accessibility interface structure 116 operates in the assembled mode by first positioning the first portion relative to the second portion so that the first and second portions of the accessibility interface structure 116 are coupled, thereby positioning the eaves structure 125 to provide the full over-cover of the capture trough, to extend radially past the outer wall structure, and to terminate at the third elevation. The accessibility interface structure 116 operates in the maintenance mode by second positioning the first portion relative to the second portion to at least partially separate the eaves structure 125 from the outer wall structure 112 to provide human accessibility to the capture trough 114 for replacement of the insect capture material 130.

In the illustrated embodiment, the first portion of the accessibility interface structure 116 is integrated with the ground component 110, and the second portion of the accessibility interface structure 116 is integrated with the skirt component 120. For example, the first portion can include grooves, and the second portion can include tongues shaped to fit within the grooves. In the assembled mode, the skirt component 120 can be placed onto the ground component 110, so that the tongues of the accessibility interface structure 116 that are integrated in the skirt component 120 fit into the grooves of the accessibility interface structure 116 that are integrated in the ground component 110. In some implementations, the first and second portions of the accessibility interface structure 116 are “coupled” by seating one of the first or second portions into the other of the first or second portions. For example, seating the tongues of the second portion into the grooves of the first portion couples the first and second portions together. In other implementations, such coupling can involve friction fitting, snap fitting, dovetail joining, mechanically fastening, and/or otherwise coupling together the first and second portions of the accessibility interface structure 116 more securely. Other implementations can couple together the first and second portions of the accessibility interface structure 116 less securely. In the illustrated embodiment, it can be seen that separating the ground component 110 and the skirt component 120 (e.g., by lifting the skirt component 120 from the ground component 110) effectively separates the eaves structure 125 from the outer wall structure 112 to provide human accessibility to the capture trough 114 for replacement of the insect capture material 130 (i.e., thereby placing the accessibility interface structure 116 in the maintenance mode).

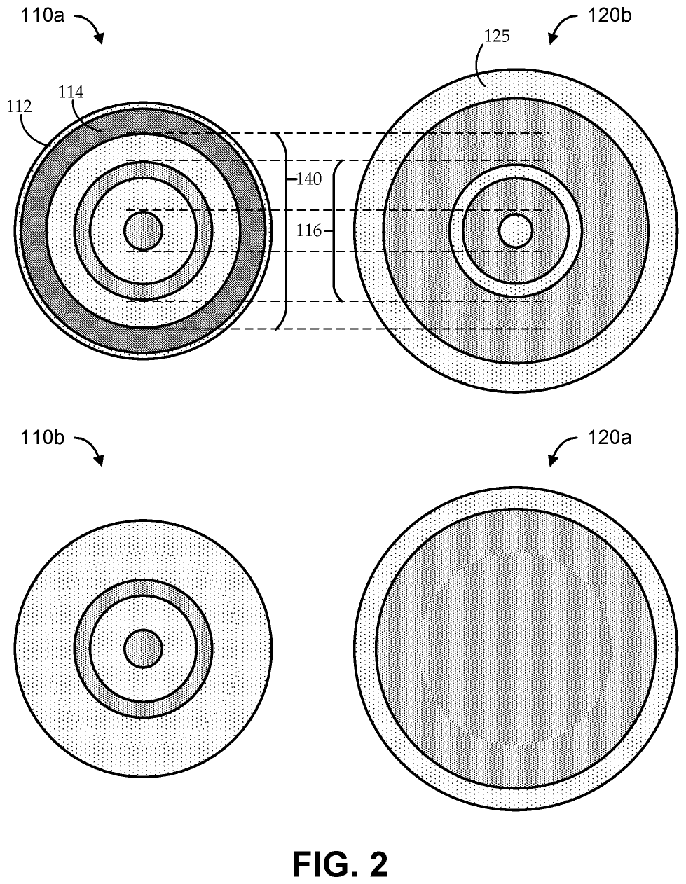

For added clarity, FIG. 2 shows top and bottom views of the ground component 110 and the skirt component 120 of the illustrative potted plant riser assembly 100 of FIG. 1B. In particular, the top and bottom views of the ground component are labeled as 110a and 110b, respectively; and the top and bottom views of the skirt component are labeled as 120a and 120b, respectively. Top view 110a is shown across from bottom view 120b to illustrate the relative positioning of the first and second portions of the accessibility interface structure 116. In the illustrated embodiment, it can be seen that features of the potted plant riser assembly 100 are generally arranged in concentric rings: The riser structure 140 is generally in the middle with the integrated accessibility interface structure 116 portions; the capture trough 114 forming a concentric ring around the riser structure 140; and the outer wall structure 112 forming a concentric ring around the capture trough 114.

In some embodiments, the accessibility interface structure 116 is configured to guide or force particular positioning of the skirt component 120 relative to the ground component 110. In the illustrated embodiment of FIG. 2, the portions of the accessibility interface structure 116 are implemented as centered and concentric rings. As such, seating the skirt component 120 onto the ground component 110 via the accessibility interface structure 116 automatically tends to center the skirt component 120 relative to the ground component 110 and generally restricts lateral movement of the skirt component 120 relative to the ground component 110, but does not tend to limit rotational movement of the skirt component 120 relative to the ground component 110. Other implementations of the accessibility interface structure 116 can be designed to permit and/or restrict movement in different ways. For example, an additional tongue and groove extending radially an linearly over a portion of the riser structure 140 area can restrict rotational movement (i.e., spinning) of the skirt component 120 relative to the ground component 110. Similarly, other types of accessibility interface structure 116 features can restrict or permit movement in various ways. For example, features that couple together more securely can further restrict relative motion of the components.

The bottom view 110b of the ground component 110 shows an illustrative contour, as illustrated in FIG. 1B. For example, the bottom of the ground component 110 can include circular channels directly opposite features of the accessibility interface structure 116. In other implementations, the bottom of the ground component 110 is flat, or substantially featureless. In other implementations, the ground component 110 has various channels, holes, divots, spikes, and/or other structural elements to provide features, such as to reduce material weight and/or cost, to aid in manufacturability, to help secure the ground component 110 to the ground, to provide pathways for irrigation components, etc.

The top view 120a of the skirt component 120 is illustrated simply as a flat platform surrounded by the eaves structure 125. The flat platform can be the top of the platform portion 144 of the riser structure 140. A portion of the flat platform (i.e., beyond a certain radial distance from a center axis of the potted plant riser assembly 100) can be considered as the start of the eaves structure 125. In other implementations, the top of the skirt component 120 can include additional structures for utilitarian purposes (e.g., to help secure a planter on top of the platform, to aid with drainage of water, to support other structures, etc.) and/or for aesthetic purposes.

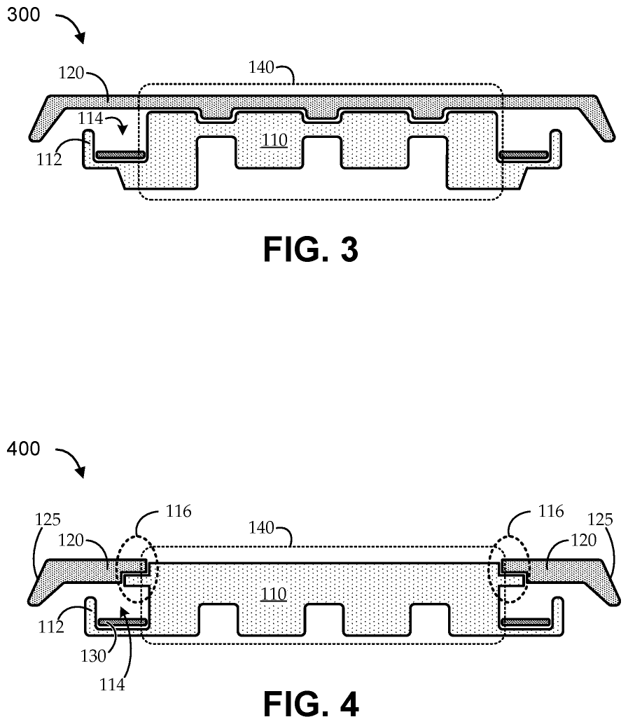

The illustrative potted plant riser assembly 100 shown in FIGS. 1B and 2 shows a particular configuration of features. FIGS. 3-10 show additional configurations of features to demonstrate a non-limiting set of possible alternative embodiments. It will be appreciated that each illustrated embodiment is intended to highlight particular features without limiting their contextual implementation. For example, those of skill in the art will appreciate that features from different illustrated embodiments can be combined, exchanged, or otherwise modified without departing from the scope of the claimed invention.

Turning first to FIG. 3, a cut view of an illustrative potted plant riser assembly 300 is shown in which the outermost boundary of the outer wall structure 112 is not the location of point of falls outside the full circumferential contact with the ground surface. The cut view can be along the cut plane of FIG. 1A, or the like. As described above, in some embodiments (e.g., such as shown in FIG. 1B), the outer boundary of the outer wall structure 112 is fully in contact with a ground surface when the potted plant riser assembly is placed in a flat and upright manner on the ground surface. In other embodiments, (e.g., such as shown in FIG. 3), the outer boundary of the outer wall structure 112 is not in contact with the ground surface (e.g., not at all, or not fully), but the outer wall structure 112 (e.g., or an outer circumference of the riser structure 140) extends downward to fully contact the ground surface. Various modification can be made so long as such full circumferential ground contact is present to prevent ground access to the platform portion 144 of the riser structure 140 (i.e., to a planter placed thereon) by crawling insects from all directions.

FIG. 4 shows a cut view of an illustrative potted plant riser assembly 400 in which the skirt component 120 only includes the eaves structure 125. The cut view can be along the cut plane of FIG. 1A, or the like. As illustrated, the outer wall structure 112, the capture trough 114, and the riser structure 140 are all integrated into the ground component 110. A first portion of the accessibility interface structure 116 is also integrated into the ground component 110 as a shelf, or other lower support structure on which to seat the skirt component 120. A second portion of the accessibility interface structure 116 is integrated into the skirt component 120 as a lip, or other upper support structure by which to support the skirt component 120 (i.e., the eaves structure 125) on the lower support structure. It can be seen that the accessibility interface structure 116 operates in the assembled mode when the skirt component 120 is seated on the ground component 110 via the first and second portions of the accessibility interface structure 116, and the accessibility interface structure 116 operates in the maintenance mode when the skirt component 120 is removed from the ground component 110 via the first and second portions of the accessibility interface structure 116. In particular, removing the skirt component 120 from the ground component 110 provides human access to the insect capture material 130 in the capture trough 114.

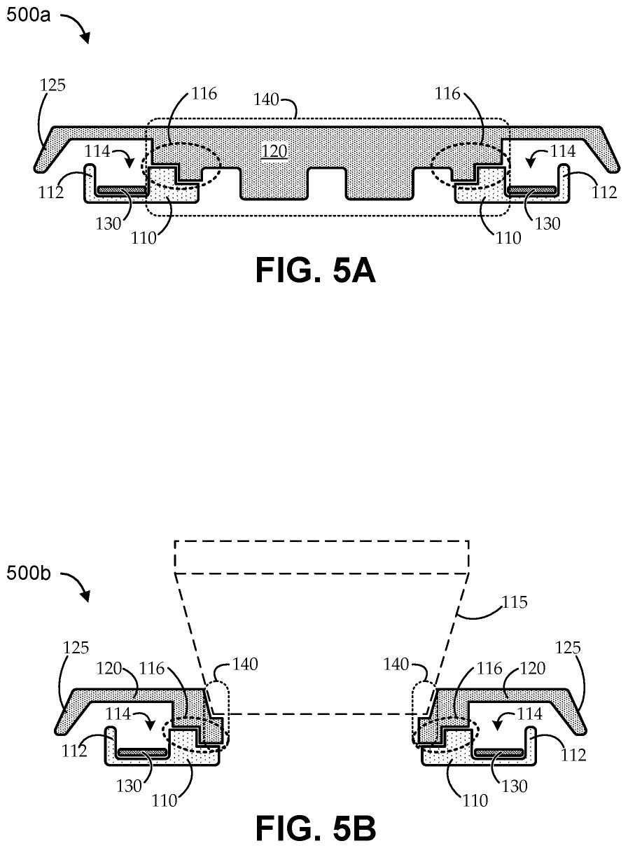

FIGS. 5A and 5B show cut views of two embodiments of an illustrative potted plant riser assembly 500 in which the outer wall structure 112 and the capture trough 114 are integrated into the ground component 110, and the riser structure 140 and the eaves structure 125 are integrated into the skirt component 120. The cut view can be along the cut plane of FIG. 1A, or the like. A first portion of the accessibility interface structure 116 is also integrated into the ground component 110 as a shelf, or other lower support structure on which to seat the skirt component 120. A second portion of the accessibility interface structure 116 is integrated into the skirt component 120 as an upper support structure by which to support the skirt component 120 on the lower support structure. It can be seen that the accessibility interface structure 116 operates in the assembled mode when the skirt component 120 is seated on the ground component 110 via the first and second portions of the accessibility interface structure 116, and the accessibility interface structure 116 operates in the maintenance mode when the skirt component 120 is removed from the ground component 110 via the first and second portions of the accessibility interface structure 116. In particular, removing the skirt component 120 from the ground component 110 provides human access to the insect capture material 130 in the capture trough 114.

In FIG. 5A, the riser structure 140 fills the central portion of the assembly 500 and is configured to at least partially contact the ground. For example, the ground component 110 is designed generally in the shape of a ring, and the riser structure 140 is essentially a solid structure that sits on and within the ring. In FIG. 5B, both the ground component 110 and the skirt component 120 are designed generally in the shape of a ring. As such, the riser structure 140 essentially provides a raised shelf onto which a planter 115 can be seated (e.g., an illustrative planter 115 is shown for context in dashed lined). In an alternative embodiment, the assembly can be designed without any riser structure 140. For example, the “rings” provided by the ground component 110 and the skirt component 120 leave a central empty region that is large enough for the planter 115 to be placed directly on the ground (or other supporting surface or structure) within the “rings.”

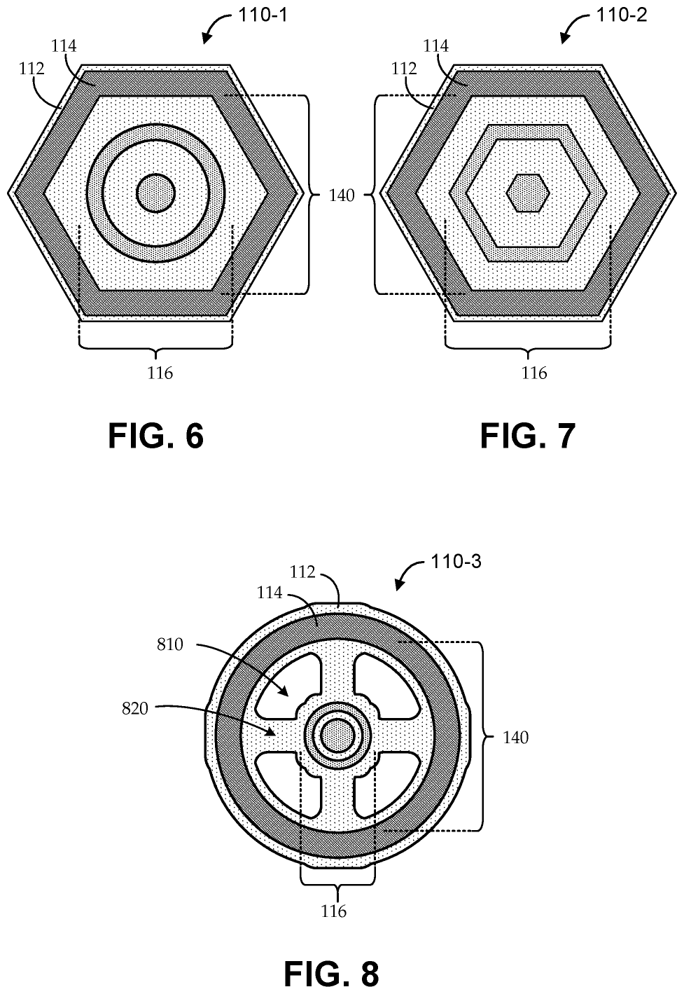

FIGS. 6 and 7 show top views of illustrative ground components 110-1 and 110-2, respectively, both having a hexagonal planar shape. As used herein, the term “planar” is intended to mean from a top-view perspective. The various embodiments illustrated above are all shown as having a generally circular planar shape. However, the potted plant riser assembly can be implemented using any suitable planar shape, such as any regular or irregular polygon, any symmetrical or asymmetrical shape, etc. Further, while it can be desirable for the various features of the potted plant riser assembly to be implemented generally in concentric rings, those rings do not have to be circular, and they do not have to have the same planar contour. In FIG. 6, the outer wall structure 112 and the capture trough 114 generally follow a generally hexagonal planar contour, but the portions of the accessibility interface structure 116 follow a generally circular planar contour. In FIG. 7, the outer wall structure 112 and the capture trough 114 again generally follow a generally hexagonal planar contour, and the portions of the accessibility interface structure 116 also follow a same generally hexagonal planar contour.

FIG. 8 shows another top view of an illustrative ground component 110-3 having a non-solid planar shape. As shown, the general structure of the ground component 110-3 includes empty regions 810. Such a configuration can be adopted for utilitarian reasons (e.g., to reduce weight and/or material costs) and/or for aesthetic reasons. For example, the riser structure 140 can include spoke structures 820 (i.e., between the empty regions 810), and the spoke regions can have vertical contour to act as riser legs, or the like. It can be seen that such embodiments can still generally have features arranged concentrically, such as generally having the riser structure 140 surrounded by the capture trough 114, and the capture trough 114 surrounded by the outer wall structure 112.

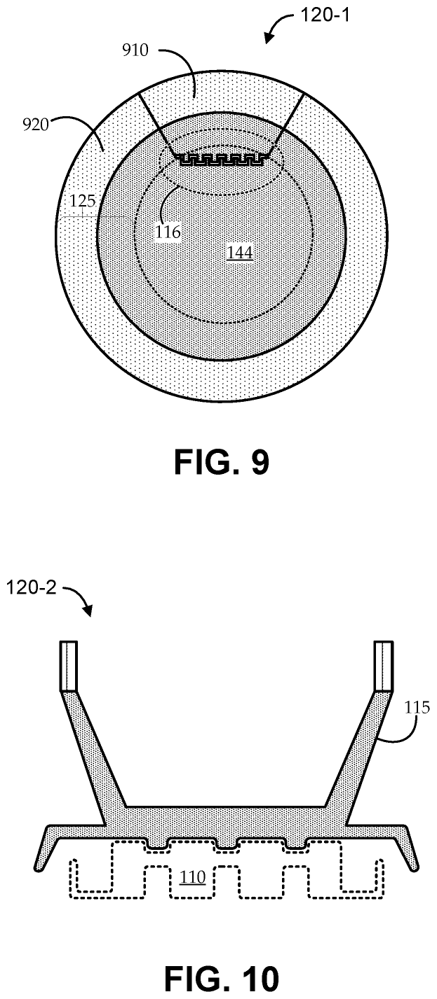

FIG. 9 shows a top view of an illustrative skirt component 120-1 having a door substructure 910. The eaves structure 125 is generally integrated with the skirt component 120 to form an outer structure around the platform portion 144 of the riser structure 140 (a dashed circle shows an illustrative boundary between the platform portion 144 within the circle and the eaves structure 125 outside the circle). A portion of the eaves structure 125 is a primary substructure 920, and a portion of the eaves structure 125 is a door substructure 910. The door substructure can be integrated with the first portion of the accessibility interface structure 116, and the platform portion 144 can be integrated with the second portion of the accessibility interface structure 116. It can be seen that accessibility interface structure 116 operates in the assembled mode by first positioning the first portion relative to the second portion thereby closing the door substructure 910, and the accessibility interface structure 116 operates in the maintenance mode by second positioning the first portion relative to the second portion thereby opening the door substructure 910. In one implementation, the first and second portions of the accessibility interface structure 116 are coupled together to form a hinging mechanism, such that the door substructure 910 can be opened or closed via the hinging mechanism. In other implementations, the first and second portions of the accessibility interface structure 116 are coupled together by snap-fitting, or any other suitable mechanism, to facilitate opening and closing of the door substructure 910 by removing and replacing the door substructure 910, respectively.

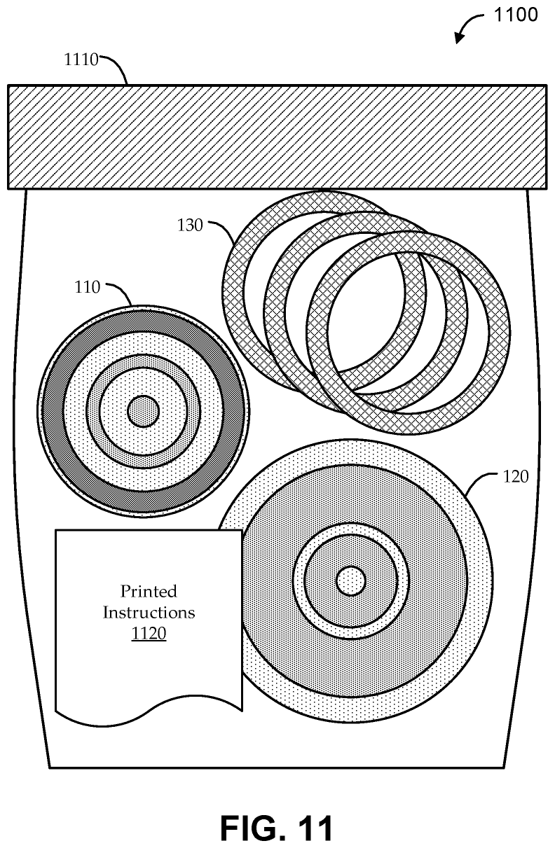

FIG. 10 shows a cut view of another illustrative skirt component 120-2 having an integrated planter 115. The cut view can be along cut plane A of FIG. 1A, or the like. In such embodiments, the integrated planter 115 can be any suitable size, shape, material, etc. Alternatively, the integrated planter 115 can be configured as a base, sleeve, support, and/or other structure designed to hold a non-integrated planter 115. The integrated planter 115 can include other features, such as integrated channels for irrigation, etc.

Some embodiments are implemented as a kit of pieces that can be assembled by an end consumer. For example, FIG. 11 shows a kit 1100 of parts for a potted plant riser assembly, according to various embodiments. The kit 1100 can include a ground component 110, a skirt component 120, and insect capture material 130. In some embodiments, the parts of the kit 1100 can be distributed and/or sold in packaging 1110. For example, each part of the kit 1100 can be within the packaging 1110, attached to the packaging 1110, etc. Some embodiments of the kit 1100 also include printed instructions 1120 (e.g., as a separate instruction sheet or manual, as printed on the packaging 1110, etc.).

Some embodiments of the kit 1100 can include an amount of insect capture material 130 suitable for a single use. In one such embodiment, a single sticky ring of insect capture material 130 is sold in the kit 1100 to be placed in the capture trough 114 during use of the potted plant riser assembly (e.g., which may last for some period of time), and additional replacement sticky rings of insect capture material 130 can be purchased separately. Some embodiments of the kit 1100 can include additional amounts of insect capture material 130. In one such embodiment, multiple sticky rings of insect capture material 130 are sold in the kit 1100, each to be placed (one at a time) in the capture trough 114 during use of the potted plant riser assembly.

It will be understood that, when an element or component is referred to herein as “connected to” or “coupled to” another element or component, it can be connected or coupled to the other element or component, or intervening elements or components may also be present. in contrast, when an element or component is referred to as being “directly connected to,” or “directly coupled to” another element or component, there are no intervening elements or components present between them. It will be understood that, although the terms “first,” “second,” “third,” etc. may be used herein to describe various elements, components, these elements, components, regions, should not be limited by these terms. These terms are only used to distinguish one element, component, from another element, component. Thus, a first element, component, discussed below could be termed a second element, component, without departing from the teachings of the present invention.

As used herein, the terms “a”, “an” and “the” may include singular and plural references. It will be further understood that the terms “comprising”, “including”, having” and variants thereof, when used in this specification, specify the presence of stated features, steps, operations, elements, and/or components, but do not preclude the presence or addition of one or more other features, steps, operations, elements, components, and/or groups thereof In contrast, the term “consisting of” when used in this specification, specifies the stated features, steps, operations, elements, and/or components, and precludes additional features, steps, operations, elements and/or components. Furthermore, as used herein, the words “and/or” may refer to and encompass any possible combinations of one or more of the associated listed items.

While the present invention is described herein with reference to illustrative embodiments, this description is not intended to be construed in a limiting sense. Rather, the purpose of the illustrative embodiments is to make the spirit of the present invention be better understood by those skilled in the art. In order not to obscure the scope of the invention, many details of well-known processes and manufacturing techniques are omitted. Various modifications of the illustrative embodiments, as well as other embodiments, will be apparent to those of skill in the art upon reference to the description. It is therefore intended that the appended claims encompass any such modifications.

Furthermore, some of the features of the preferred embodiments of the present invention could be used to advantage without the corresponding use of other features. As such, the foregoing description should be considered as merely illustrative of the principles of the invention, and not in limitation thereof. Those of skill in the art will appreciate variations of the above-described embodiments that fall within the scope of the invention. As a result, the invention is not limited to the specific embodiments and illustrations discussed above, but by the following claims and their equivalents.

What is claimed is:

1. A potted plant riser assembly comprising:
an outer wall structure extending from a ground level to a first elevation above the ground level;
a riser structure configured to support a bottom of a planter at a second elevation above the first elevation;
a capture trough surrounding the riser structure, bounded at least partially by the outer wall structure, and sized to removably receive insect capture material; and
an eaves structure configured, in an assembled mode, to provide full over-cover of the capture trough, to extend radially past the outer wall structure, and to terminate at a third elevation between the ground and the first elevation.

2. The potted plant riser assembly of claim 1, wherein:
the outer wall structure is configured to be in full circumferential contact with a ground surface when the potted plant riser assembly is placed in a flat and upright manner on the ground surface, the full circumferential contact preventing ground access to the riser structure by crawling insects except via the outer wall structure and the capture trough.

3. The potted plant riser assembly of claim 1, further comprising:
an accessibility interface structure comprising a first portion and a second portion configured to operate in either of the assembled mode or a maintenance mode,
wherein the accessibility interface structure operates in the assembled mode by first positioning the first portion relative to the second portion thereby positioning the eaves structure to provide the full over-cover of the capture trough, to extend radially past the outer wall structure, and to terminate at the third elevation coupling the first and second components; and
the accessibility interface structure operates in the maintenance mode by second positioning the first portion relative to the second portion to at least partially separate the eaves structure from the outer wall structure to provide human accessibility to the capture trough for replacement of the insect capture material.

4. The potted plant riser assembly of claim 3, wherein:
the riser structure comprises a platform portion and an elevation portion to elevate the platform portion to the second elevation;
the outer wall structure, the capture trough, the first portion of the accessibility interface structure, and the elevation portion integrally form a first component;
the platform portion, the eaves structure, and the second portion of the accessibility interface structure integrally form a second component,
such that the first and second components are separable via the first and second portions of the accessibility interface structure.

5. The potted plant riser assembly of claim 3, wherein:
the outer wall structure, the capture trough, the riser structure, and the first portion of the accessibility interface structure integrally form a first component; and
the eaves structure and the second portion of the accessibility interface structure integrally form a second component,
such that the first and second components are separable via the first and second portions of the accessibility interface structure.

6. The potted plant riser assembly of claim 3, wherein:
the outer wall structure, the capture trough, and the first portion of the accessibility interface structure integrally form a first component; and
the eaves structure, the riser structure, and the second portion of the accessibility interface structure integrally form a second component,
such that the first and second components are separable via the first and second portions of the accessibility interface structure.

7. The potted plant riser assembly of claim 3, wherein:
the eaves structure comprises a primary substructure and a door substructure;
the primary substructure is integrated with at least a portion of the riser structure;
the door substructure is integrated with the first portion of the accessibility interface structure; and
the riser structure is integrated with the second portion of the accessibility interface structure,
such that the accessibility interface structure operates in the assembled mode by first positioning the first portion relative to the second portion thereby closing the door substructure, and the accessibility interface structure operates in the maintenance mode by second positioning the first portion relative to the second portion thereby opening the door sub structure.

8. The potted plant riser assembly of claim 1, wherein:
the riser structure has a circular planar shape;
the capture trough forms a ring completely encircling the riser structure; and
the outer wall structure forms a ring completely encircling the capture trough.

9. The potted plant riser assembly of claim 1, wherein:
the riser structure comprises the planter.

10. A kit comprising:
potted plant riser assembly comprising:
an outer wall structure extending from a ground level to a first elevation above the ground level and defining an outer ground perimeter;
a riser structure configured to support a bottom of a planter at a second elevation above the first elevation;
a capture trough surrounding the riser structure, bounded at least partially by the outer wall structure, and sized to removably receive insect capture material; and
an eaves structure configured, in an assembled mode, to provide full over-cover of the capture trough, to extend radially past the outer wall structure, and to terminate at a third elevation between the ground and the first elevation;
the insect capture material; and
packaging configured to hold the potted plant riser and the insect capture material.

11. The kit of claim 10, wherein:
the insect capture material is configured to be removably installed within the capture trough to form a contiguous ring around the riser structure.

12. The kit of claim 11, wherein:
the insect capture material is formed on a substrate shaped to fit within the capture trough and to follow a planar contour of the capture trough.

13. The kit of claim 10, wherein:
the insect capture material comprises multiple replaceable instances of the insect capture material, each instance of the insect capture material being configured to be removably installed within the capture trough to form a contiguous ring around the riser structure.

14. The kit of claim 10, wherein the potted plant riser assembly further comprises:
an accessibility interface structure comprising a first portion and a second portion configured to operate in either of the assembled mode or a maintenance mode,
wherein the accessibility interface structure operates in the assembled mode by first positioning the first portion relative to the second portion thereby positioning the eaves structure to provide the full over-cover of the capture trough, to extend radially past the outer wall structure, and to terminate at the third elevation coupling the first and second components; and
the accessibility interface structure operates in the maintenance mode by second positioning the first portion relative to the second portion to at least partially separate the eaves structure from the outer wall structure to provide human accessibility to the capture trough for replacement of the insect capture material.

15. The kit of claim 14, wherein:
the potted plant riser assembly comprises a first unitary component and a second unitary component;
the first unitary component integrates the outer wall structure, the capture trough, the first portion of the accessibility interface structure, and an elevation portion of the riser structure;
the second unitary component integrates the eaves structure, the second portion of the accessibility interface structure, and a platform portion of the riser configured to sit elevated on top of the elevation portion; and
the packaging is configured to hold the first and second unitary components.

16. The kit of claim 14, wherein:
the potted plant riser assembly comprises a first unitary component and a second unitary component;
the first unitary component integrates the outer wall structure, the capture trough, the riser structure, and the first portion of the accessibility interface structure;
the second unitary component integrates the eaves structure and the second portion of the accessibility interface structure; and
the packaging is configured to hold the first and second unitary components.

17. The kit of claim 14, wherein:
the potted plant riser assembly comprises a first unitary component and a second unitary component;
the first unitary component integrates the outer wall structure, the capture trough, and the first portion of the accessibility interface structure;
the second unitary component integrates the eaves structure, the riser structure, and the second portion of the accessibility interface structure; and
the packaging is configured to hold the first and second unitary components.

18. The kit of claim 14, wherein:
the eaves structure comprises a primary substructure and a door substructure;
the primary substructure is integrated with at least a portion of the riser structure;
the door substructure is integrated with the first portion of the accessibility interface structure; and
the riser structure is integrated with the second portion of the accessibility interface structure,
such that the accessibility interface structure operates in the assembled mode by first positioning the first portion relative to the second portion thereby closing the door substructure, and the accessibility interface structure operates in the maintenance mode by second positioning the first portion relative to the second portion thereby opening the door substructure.

19. The kit of claim 1, further comprising:
the planter.

20. The kit of claim 19, wherein the planter is integrated with the riser.
